(19) United States
(12) Patent Application Publication
(10) Pub. No.: US 2013/0085900 A1
(43) Pub. Date: Apr. 4, 2013

(54) ENHANCING THE SEARCH EXPERIENCE IN A NETWORKED PUBLICATION SYSTEM BY IMPROVED SEARCH AND LISTING PROCESS

(71) Applicant: Diana Williams, Burlingame, CA (US)

(72) Inventor: Diana Williams, Burlingame, CA (US)

(21) Appl. No.: 13/250,490

(22) Filed: Sep. 30, 2011

(51) Int. Cl. G06Q 30/00

(52) U.S. Cl. 705/27.2

(57) ABSTRACT

A method comprising detecting an indication of entering a brand name in a search box from a client machine; responsive to detecting the indication, providing selectable images of categories of products of the brand and selectable product aspects of the products; detecting an indication of the selection of a product category and a product aspect from the client machine; responsive to detecting the indication of the selection of the product category and of the product aspect, providing selectable images of styles of products; and responsive to detecting an indication of the selection of an image of a product style, providing a number of selectable images of at least one product of the selected product category of the brand, the at least one product being of the selected style and aspect. The aspects may include a color selectable as a range of shades of the color.

### BACKGROUND

As the use of network-based publication systems and marketplaces, such as on-line commerce services or auction services expands, and the volume of item listings in such applications increases, the speed, ease, and convenience with which information can be retrieved from such marketplaces increases in importance to customers.

### BRIEF DESCRIPTION OF DRAWINGS

Some embodiments are illustrated by way of example and not limitation in the figures of the accompanying drawings in which:

FIG. 1 is a block diagram illustrating a publication system in the example form of network-based marketplace system according to an example embodiment.

FIG. 2 is a diagrammatic representation of marketplace and payment applications which may form part of the example embodiment of FIG. 1.

FIG. 3 is a diagrammatic representation of a function of a brand extraction engine in accordance with a disclosed embodiment.

FIG. 4 is a diagrammatic representation of displaying recommendations for related brands.

FIG. 5A, FIG. 5B, and FIG. 5C are illustrations of embodiments of locating silhouettes earlier in a search, and shopping by aspect on an ecommerce site.

FIG. 5D and FIG. 5E are alternate embodiments of locating silhouettes earlier in the search, and shopping by aspect on the ecommerce site.

FIG. 5F and FIG. 5G are illustrations of an embodiment for presenting related brands to a shopper on an ecommerce site.

FIG. 6A is a flow chart of a method illustrating a color picker according to an embodiment.

FIG. 6B is a flow chart illustrating operations of a color picker according to another embodiment.

FIG. 7 is a block diagram of a machine in the example form of a computer system within which a set of instructions, for causing the machine to perform any one or more of the methodologies discussed herein, may be executed.

FIG. 8 is a diagrammatic view of a data structure according to an example embodiment of a network-based marketplace.

### DETAILED DESCRIPTION

In the following description, for purposes of explanation, numerous specific details are set forth in order to provide a thorough understanding of some example embodiments. It will be evident, however, to one skilled in the art that the present embodiments may be practiced without these specific details.

Some ecommerce site search pages allow shoppers to arrive at a product category by way of a special “Category” button, which may be similar to a browser search. However, studying shoppers' online shopping habits indicates that shoppers may be more likely to purchase when they quickly arrive into a category of desired products such as men's clothes, women's clothes, and the like, and then continue their search for items to purchase. However, shoppers sometime may be frustrated by the fact that they can arrive at a product category only through the classic, browser-like, search discussed above.

Likewise the perception of color offers issues to both sellers who list products for sale on an ecommerce site and shoppers who buy products on an ecommerce site. Sellers have voiced issues concerning the listing process that allows only one color of a given shade, for example, red only, to be selected when preparing a listing for a product that is a shade of red. Faced with a choice of merely red, sellers complain that color of their product may be burgundy or brick red, but their only choice of a color for listing their product is red. Further, this scarcity of color selection can lead to a purchaser complaining that the item purchased isn't as described because it is really a burgundy but was listed as merely red.

Study of shopper's shopping habits has also shown that shoppers shop by style, brand, material, or other aspects of the product being shopped for. However, most ecommerce sites do not provide the shopper with an aspect selection until the shopper has searched down the search tree. For example, a shopper may not see a brand of an item until the shopper is searching at a lower level of the search. Yet, shoppers often shop by brand, or size, or color, or material, as examples of aspects. Study of shoppers' online habits has found that shoppers may be more likely to purchase if product aspects can be seen at an early point in the item search, so that the shopper doesn't lose interest as the shopper proceeds down the search tree.

Additional study of shoppers' shopping habits has determined that shoppers tend to focus tightly on what is presented to them in a first category. It has been shown that if an ecommerce site introduces a second category to shoppers, they tend to continue shopping in the first category, but also sometimes shop in the second category as well. This can result in increased sales. This shopper behavior may be similar for brands, as well. For example, if a shopper in shopping for Hugo Boss clothes and the shopper is then presented with Hickey-Freeman as a brand, there may be a tendency to shop in both the Hugo Boss brand and the Hickey Freeman brand. This benefits both the shopper, who may have a better probability of finding what he or she wants or needs, and the ecommerce site, that may experience higher sales. Therefore it is helpful to suggest multiple brands to a shopper. One way this may be accomplished may be to present the shopper with not only the brand for which the shopper is searching, but also present the shopper with brands related to that brand.

The system and method disclosed herein thus provides for shoppers on an ecommerce site to enter the category of products being shopped more quickly, for shopping by aspects at an earlier level of an item search tree, for better selection of color by both sellers and shoppers, and for suggesting to a shopper brands that are related to the brand the shopper is searching for. Accordingly, one or more of the methodologies discussed herein may obviate a need for additional searching or navigation by the user, which may have the technical effect of reducing computing resources used by one or more devices within the system. Examples of such computing resources include, without limitation, processor cycles, network traffic, memory usage, storage space, and power consumption.

### Architecture

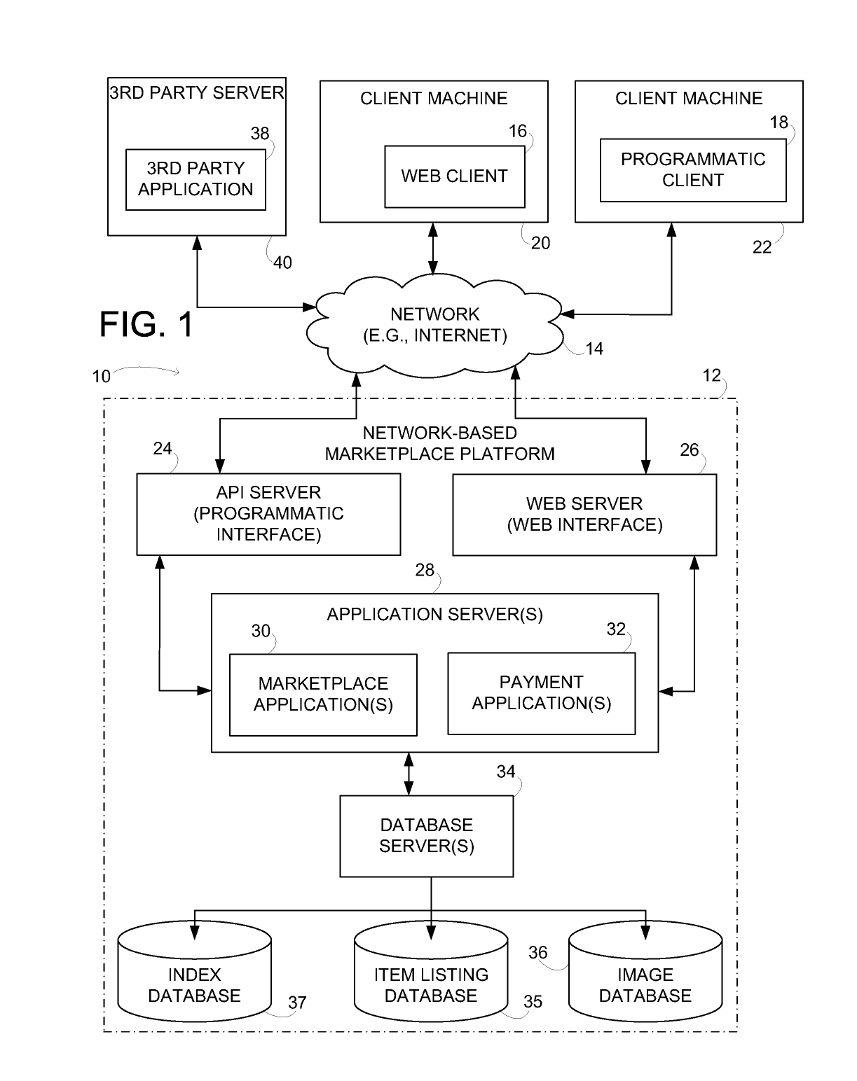

One example embodiment of a distributed network implementing image-based indexing for listings in a publication system is illustrated in the network diagram of FIG. 1, which depicts a system 10 using a client-server type architecture. A commerce platform, in the example form of a network-based marketplace platform 12, provides server-side functionality, via a network 14 (e.g., the Internet) to one or more clients. As illustrated, the platform 12 interacts with a web client 16 executing on a client machine 20 and a programmatic client 18 executing on a client machine 22. In one embodiment, web client 16 is a web browser, but it may employ other types of web services.

Turning specifically to the network-based marketplace platform 12, an Application Program Interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more databases servers 34 that facilitate access to a number of databases, in particular an item listing database 35, an image database 36, and an index database 37. The item listing database 35 stores data indicative of item listings for items which are offered for sale or auction on the platform 12. Each item listing includes, inter alia, a text description of the relevant item and metadata categorizing the item. The image database 36 includes images associated with respective item listings in the item listing database 35. The images in the image database 36 may be standard format image files such as JPEG files. The index database 37 contains index data relating to images in the image database to permit image-based searching of the image database 36. The format of index data in the index database 37 is described in more detail below.

The marketplace applications 30 provide a number of marketplace functions and services to users that access the marketplace platform 12. The payment applications 32 likewise provide a number of payment services and functions to users. The payment applications 32 may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the marketplace applications 30. While the marketplace and payment applications 30 and 32 are shown in FIG. 1 to both form part of the network-based marketplace platform 12, it will be appreciated that, in alternative embodiments, the payment applications 32 may form part of a payment service that is separate and distinct from the marketplace platform 12.

Further, while the system 10 shown in FIG. 1 employs a client-server architecture, the present invention is of course not limited to such an architecture, and could equally well find application in a distributed, or peer-to-peer, architecture system. The various marketplace and payment applications 30 and 32 could also be implemented as standalone software programs, which do not necessarily have networking capabilities. Additionally, while example embodiments are described with respect to the marketplace platform 12, alternative embodiments may be contemplate use on a publication platform or other non-commerce platforms.

The web client 16, it will be appreciated, accesses the various marketplace and payment applications 30 and 32 via the web interface supported by the web server 26. Similarly, the programmatic client 18 accesses the various services and functions provided by the marketplace and payment applications 30 and 32 via the programmatic interface provided by the API server 24. The programmatic client 18 may, for example, be a seller application (e.g., the TurboLister application developed by eBay Inc., of San Jose, Calif.) to enable sellers to author and manage listings on the marketplace platform 12 in an off-line manner, and to perform batch-mode communications between the programmatic client 18 and the network-based marketplace platform 12.

FIG. 1 also illustrates a third party application 38, executing on a third party server machine 40, as having programmatic access to the network-based marketplace via the programmatic interface provided by the API server 24. For example, the third party application 38 may, utilizing information retrieved from the network-based marketplace platform 12, support one or more features or functions on a website hosted by the third party. The third party website may, for example, provide one or more promotional, marketplace or payment functions that are supported by the relevant applications of the network-based marketplace platform 12.

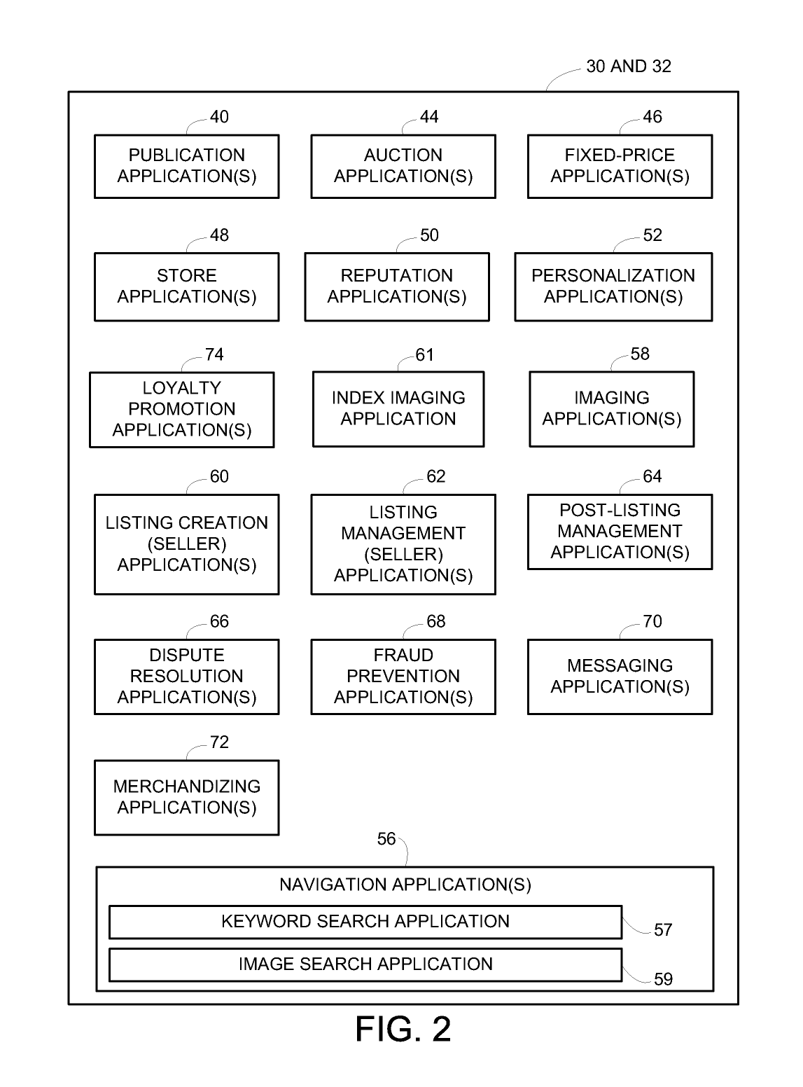

FIG. 2 is a block diagram illustrating multiple marketplace and payment applications 30 and 32 that, in one example embodiment, are provided as part of the network-based marketplace platform 12. The marketplace platform 12 may provide a number of listing and price-setting mechanisms whereby a seller may list goods or services for sale, a buyer can express interest in or indicate a desire to purchase such goods or services, and a price can be set for a transaction pertaining to the goods or services. To this end, the marketplace applications 30 are shown to include at least one publication application 40 and one or more auction applications 44 which support auction-format listing and price setting mechanisms (e.g., English, Dutch,Vickrey, Chinese, Double, Reverse auctions etc.). The various auction applications 44 may also provide a number of features in support of such auction-format listings, such as a reserve price feature whereby a seller may specify a reserve price in connection with a listing and a proxy bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based marketplace platform 12 to establish, build, and maintain reputations, which may be made available and published to potential trading partners. Consider that where, for example, the network-based marketplace platform 12 supports person-to-person trading, users may have no history or other reference information whereby the trustworthiness and credibility of potential trading partners may be assessed. The reputation application 50 allows a user, for example through feedback provided by other transaction partners, to establish a reputation within the network-based marketplace platform 12 over time. Other potential trading partners may then reference such a reputation for the purposes of assessing credibility and trustworthiness.

Personalization applications 52 allow users of the marketplace platform 12 to personalize various aspects of their interactions with the marketplace platform 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the marketplace and other parties.

In one embodiment, the network-based marketplace platform 12 may support a number of marketplaces that are customized, for example, for specific geographic regions. A version of the marketplace may be customized for the United Kingdom, whereas another version of the marketplace may be customized for the United States. Each of these versions may operate as an independent marketplace, or may be customized (or internationalized) presentations of a common underlying marketplace.

Navigation of the network based-marketplace may be facilitated by one or more navigation applications 56. For example, a keyword search application 57 enables keyword searches of listings published via the marketplace platform 12. Similarly, an image search application 59 enables an image-based search of item listings published via the marketplace platform 12. To perform an image-based search, a user may submit a query image, whereupon the image search application 59 may compare the query image to images in the image database to produce a result list of item listings based on a similarity ranking between the query image and the images associated with the respective item listings. The comparison ranking is established by parsing or processing the query image to provide index data, and thereafter comparing the query image's index data to pre-compiled index data for the listing images, as described in more detail below. A browse application allows users to browse various category, catalogue, or inventory data structures according to which listings may be classified within the marketplace platform 12. Various other navigation applications may be provided to supplement the search and browsing applications.

In order to make listings, available via the network-based marketplace, as visually informative and attractive as possible, as well as to enable image-based searching, the marketplace applications 30 may include one or more imaging applications 58, which users may use to upload images for inclusion within listings. Images thus uploaded are stored in the image database 36, each image being associatively linked to at least one item listing in the item listing database 35. One of the imaging applications 58 also operates to incorporate images within viewed listings. The imaging applications 58 may also support one or more promotional features, such as image galleries that are presented to potential buyers. For example, sellers may pay an additional fee to have an image included within a gallery of images for promoted items.

The marketplace platform 12 may also include an index imaging application 61 to parse or process images uploaded via the image application 58, as well as to parse or process query images submitted via the image search application 59. The result of processing images by the image indexing application 61 is index data which is stored in the index database 37. Particular processes for indexing images, as well as the format of index data, are discussed in more detail below.

Listing creation applications 60 allow sellers conveniently to author listings pertaining to goods or services that they wish to transact via the marketplace platform 12, and listing management applications 62 allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assists sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more reputation applications 50, so as to allow the seller conveniently to provide feedback regarding multiple buyers to the reputation applications 50.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the marketplace. One of the fraud prevention applications 68 may include automatic image comparison, by use of index data produced by the image indexing application 61 and stored in the index database 37. Such image comparison may be used by the fraud prevention application 68 automatically to detect listing images similar to the query image, and to alert a fraud assessor to such image listings, so that the human assessor can examine the identified item listing for assessing whether or not the identified item listing is a fraudulent listing.

Messaging applications 70 are responsible for the generation and delivery of messages to users of the network-based marketplace platform 12, such messages for example advising users regarding the status of listings at the marketplace (e.g., providing “outbid” notices to bidders during an auction process or providing promotional and merchandising information to users).

Merchandising applications 72 support various merchandising functions that are made available to sellers to enable sellers to increase sales via the marketplace platform 12. The merchandising applications 72 also operate the various merchandising features that may be invoked by sellers, and may monitor and track the success of merchandising strategies employed by sellers.

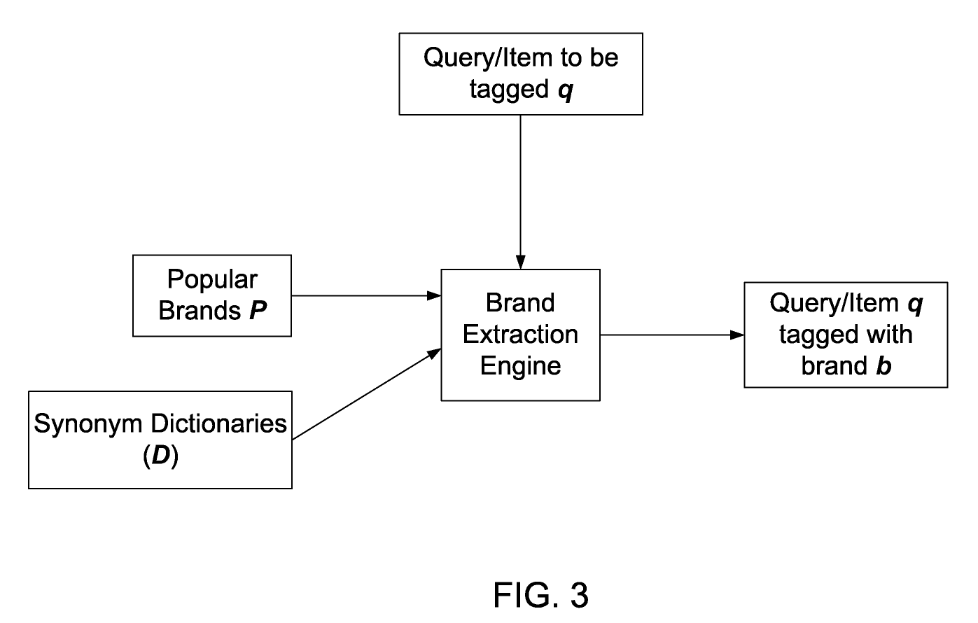

FIG. 3 is a high-level entity-relationship diagram, illustrating the relationship between the databases 35 to 37 and several functional modules forming part of the applications 30 and 32. The system includes a receiving module 80, which may form part of the image search application 59 (FIG. 2), for receiving a listing query which includes a query image. Query images which may be submitted to the receiving module 80 are typically electronic image files in a standard format, such as JPEG, GIF, TIFF, etc.

As discussed earlier, if a user is presented with related brands, within and across categories, the shopping experience can be enhanced. One embodiment for determining related brands is seen below.

### Semantic Query Network (S):

By looking at queries performed by eBay users and appropriate user sessions, a network of queries may be created. In this network, queries may be connected with each other based on textual information as well as information inferred from queries, BINs, BIDs, and other activities performed by eBay users. More information may be found in “Inferring Semantic Query Relations from Collective User Behavior” {nparikh, nsundaresan}@ebay.com, CIKM 2008). For example, Nike shoes may be related to Reebok shoes, and Gucci bags may be related to Coach wallets and so on.

### Popular Brands (P):

A seed list of popular brands on eBay may be provided by ecommerce system Category Managers. This set may be expanded to include more brands bought/sold on ecommerce systems by mining semantically similar brands from S. The set of popular brands thus obtained is referred to as P.

### Brand Extraction Engine (BEE):

In an example embodiment, a BEE may be used to determine a brand intent in queries and item titles. The BEE may take in the list P as input. The BEE may also take in various sources/dictionaries which may provide synonyms for the values in P. Using this information, it may tag a query or product or title with a particular brand. Details are shown in the block diagram of FIG. 3.

D may include dictionaries built using publication system data or external sources. These dictionaries will have synonyms of the form (d&g=dolce & gabbana; bcbg=bcbg max azria et al.).

BEE may take any query or item title as input and tag it with the correct brand. Some examples are given below:

| Query / Item q | Brand tagged by BEE b |
|---|---|
| Query = 3com 7760 | 3Com |
| Query = air jet nike | Nike |
| Query = New slippers | None |
| Item = NEW WOMENS | Naturalizer |
| NATURALIZER WHITE LEATHER | |
| SANDALS 8.5M $59 | |

### Query to Category Mapper (M):

By looking at past user activity M may map a query q to a category c. If in the history of user sessions after doing the query “battery,” 90% of people clicked on items listed in Category 81074 (Computers & Networking>Pc Components>For Desktops>Power Supplies>Standard ATX Power Supplies) and a remaining 10% of users clicked on items listed in Category 3312(Cell Phones & PDAs>Cell Phones & Smartphones) then M will decompose the query q=“battery” into a vector (cat-81074=90, cat-3312=10).

### Brand Category Recommendations Index (I):

An example algorithm to build the index I₁ is as follows:
Build Semantic Query Network S
Find all relationships in S that map one brand to another brand or one product of a brand to another product of the same brand. This is done by passing every relationship in S through BEE and keeping only those relationships which are tagged as brands by BEE.
Map all relationships found in previous step to their category vectors using M.
Score each of the relationship obtained in previous step using a function of scores obtained from Semantic Query Network S and Query to Category Mapper M.

An example algorithm to build the index I₂ is as follows:
Look at all items sold for some time interval (say 3 months).
Pass the item titles through BBE to find all the items that are associated with a Brand.
Look at these items with their categories and buyer identities and build a map of items bought by the same buyer.
We use a function to determine relationships between brands and categories based on interestingness to same buyer. For example if a buyer bought Nike shoes and Gucci bag, then the brand Nike in category shoes will be related to the brand Gucci in category bags.

A final index I may be formed by merging indices I₁ and I₂. I₁ is a measure of how likely a user is to be interested in brand x/category y given that she is interested in brand xₚ and category yₚ. I₂ is a measure of how likely a user is to buy brand x/category y given that she bought brand xₚ/category yₚ. Here x may or may not be equal to xₚ and y may or may not be equal to yₚ. While merging the indices, what weights to use for I₁ and I₂ is determined by the use case. The weights will be different if the recommendations are to be displayed on a search page versus a post auction win merchandizing email and so on.

The relationships obtained in index I may be as follows:
S&S:6304 S&S:6244 0.02
Dooney & Bourke:63852 Coach:63852 4291.83071269206
Onkyo:72406 Yamaha:3280 0.020290622061829

The above means that the brand S&S in category 6304 is related to the brand S&S in category 6244(Same Brand/Different Category); The brand Dooney&Burke in category 63852 is related to the brand Coach in category 63852(Different Brand/Same Category); the brand Onkyo in category 72406 is related to the brand Yamaha in category 3280 (Different Category/Different Brand) and 0.02, 4291.83 . . . and 0.02029 . . . indicate the strengths of these relationships.

These relationships may be pruned based on strength scores. These relationships may also be used to find out popular brands in a category and popular categories for a brand.

### Displaying Recommendations:

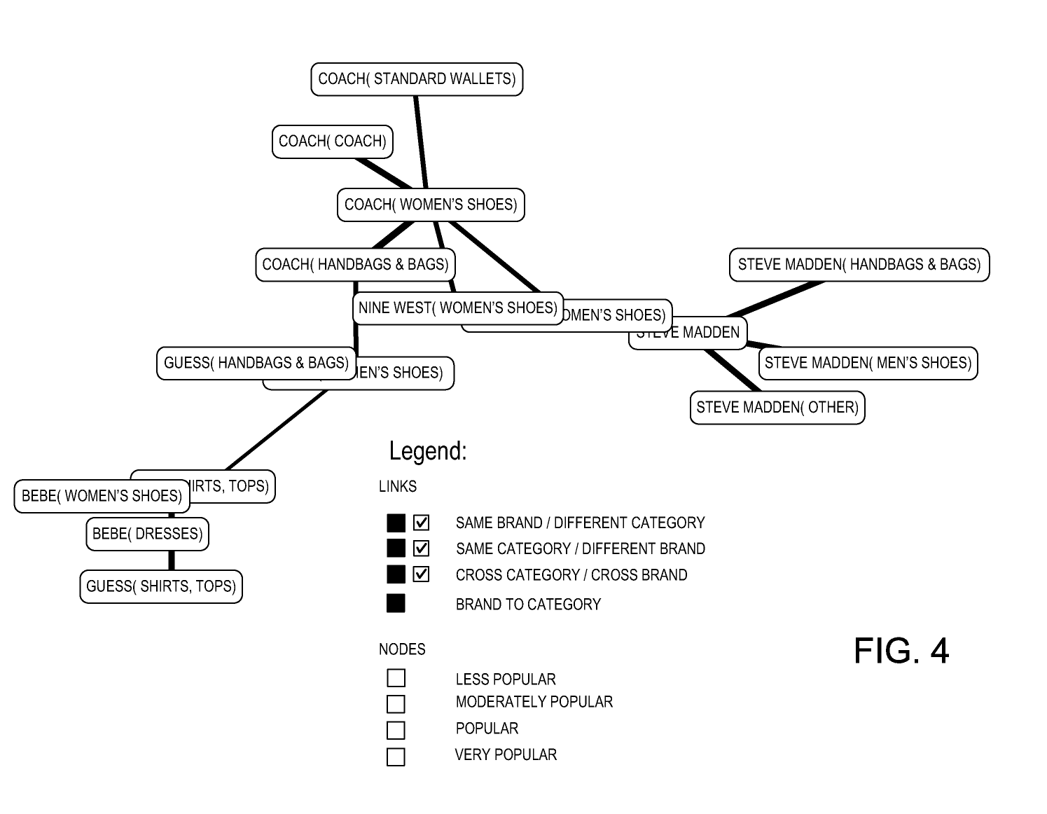

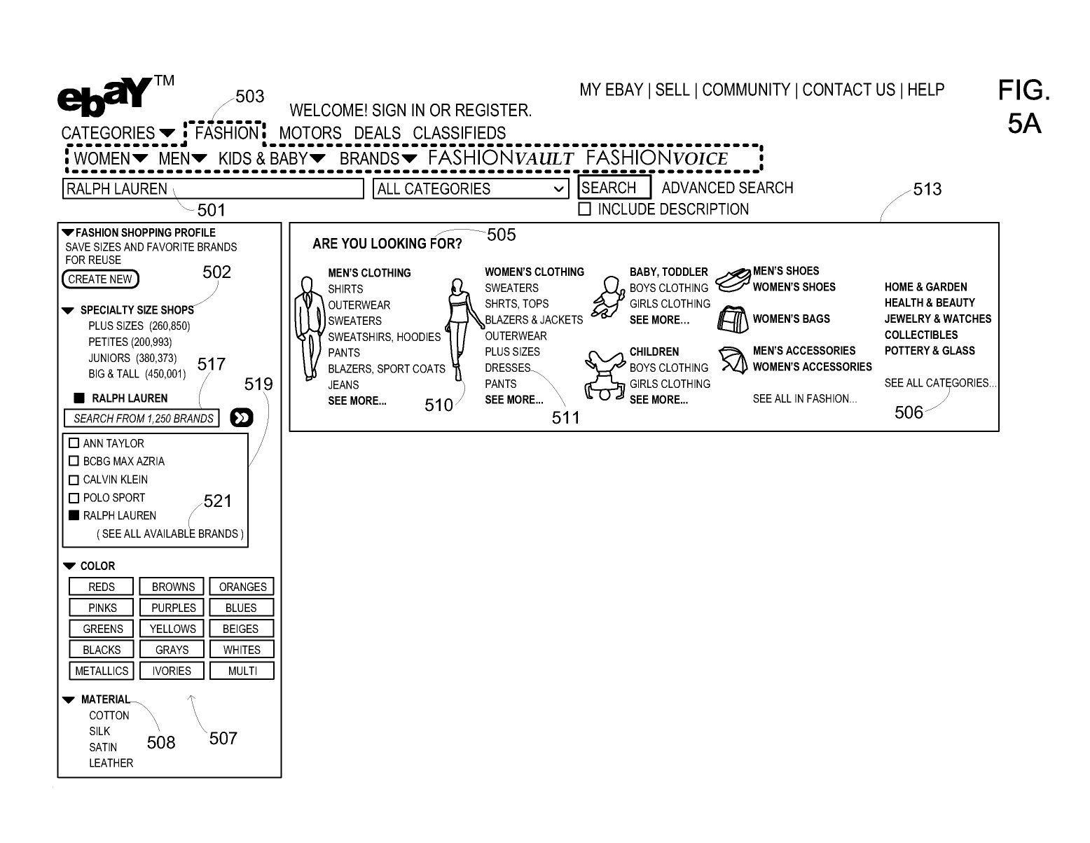

In the example interface shown in FIG. 4, the user may be allowed to choose what kind of recommendations he or she desires. The recommendation may be one or more of Same Brand/Different Category, Same Category/Different Brand and Cross Category/Cross Brand, which may be selected using checkboxes. A color of each node indicates popularity of the brand. Colors of edges indicate a kind of relationship between the nodes. Also, a thickness of the edges indicates the strength score for the relationship between the nodes.

### Enhanced Search

A commonly used ecommerce web site navigation page may be seen in U.S. patent application Ser. No. 13/073,926 entitled “TWO-PASS SEARCHING FOR IMAGE SIMILARITY OF DIGESTS OF IMAGE-BASED LISTINGS IN A NETWORK-BASED PUBLICATION SYSTEM,” filed Mar. 28, 2011 and incorporated herein by reference in its entirety. The page illustrates how a shopper may navigate to a product category by beginning at a selectable category button such as “Fashion” and then ultimately refining down to the desired item. This may be called a classic search.

It has been discovered by studying shoppers’ online shopping habits that shoppers may be more likely to purchase when they quickly get into a product category such as, for example, men's clothes or women's clothes, and then continue their search as above. However, shoppers sometimes may be frustrated by the fact that they may arrive at a product category only through the classic, browser-like, search discussed above. Shoppers' habits indicate a desire to enter into a category by using the search box found at the top of a search page seen in the application cited next above.

This desire may be fulfilled by designing the search page so that the shopper may be presented with a plurality of category choices, as if being asked a question such as “what are you looking for?” “Are you looking for men's clothing?” That is, the shopper may be presented with categories to select, much like answering the question by continuing their search in the selected category. This may be done by silhouettes that indicate product categories, or it may be done by a pop-up window that indicates product categories, or a combination of both. Silhouettes that may be adapted for this purpose may be seen in U.S. patent application Ser. No. 13/011,510 entitled “MULTILEVEL SILHOUETTES IN AN ONLINE SHOPPING ENVIRONMENT,” filed Jan 21, 2011, Incorporated herein by reference in its entirety.

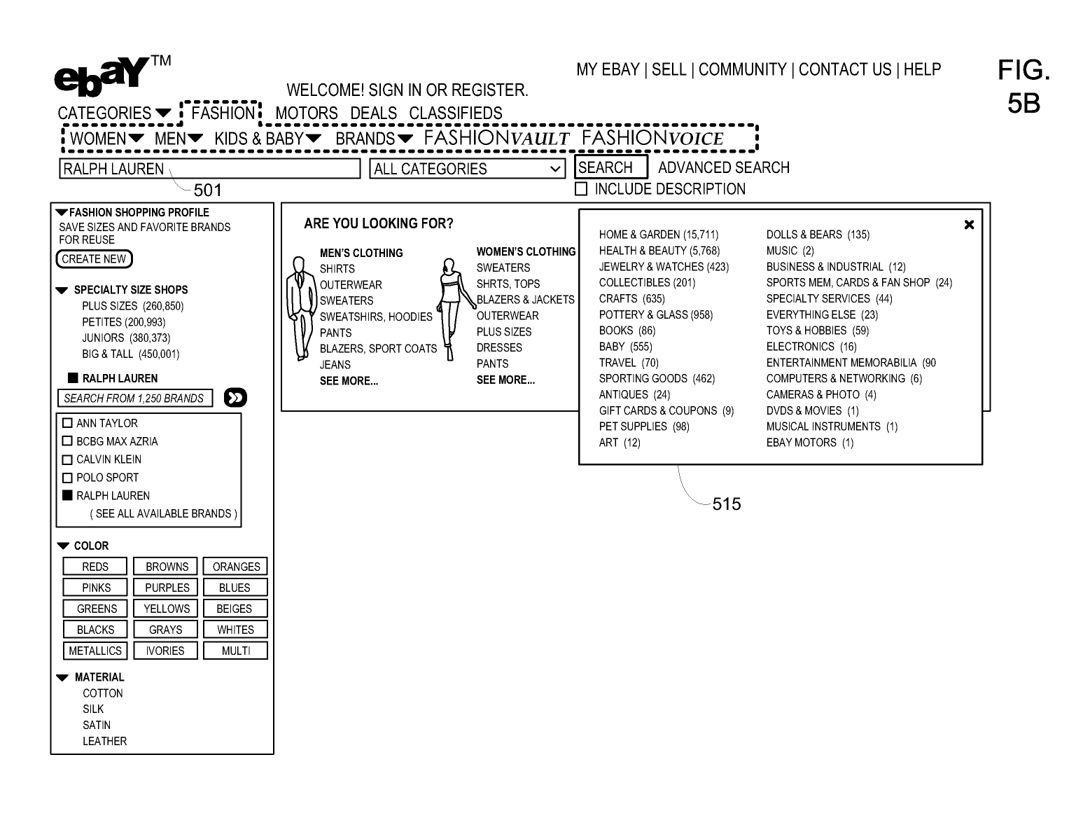

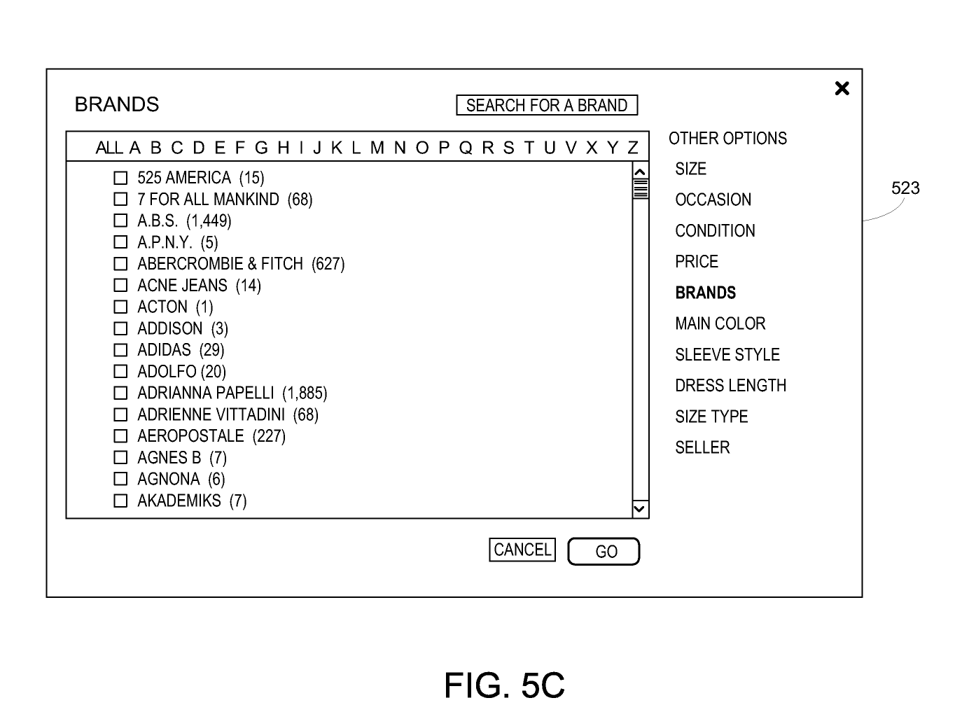

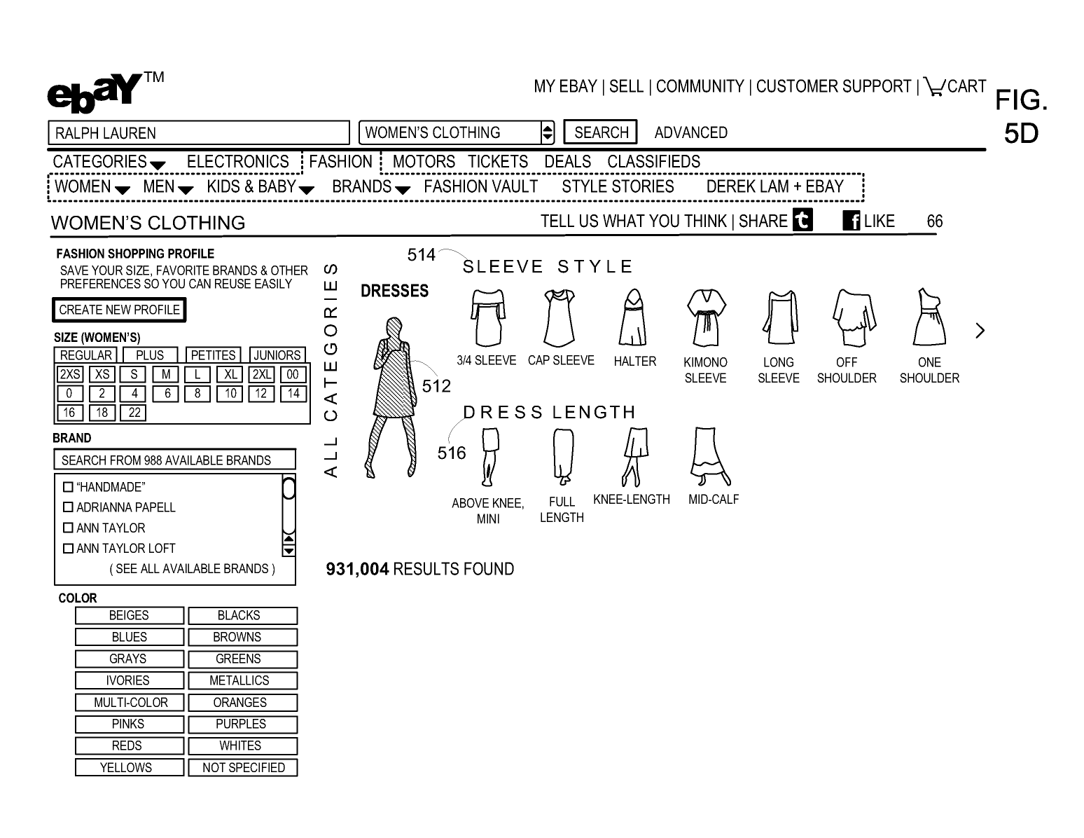

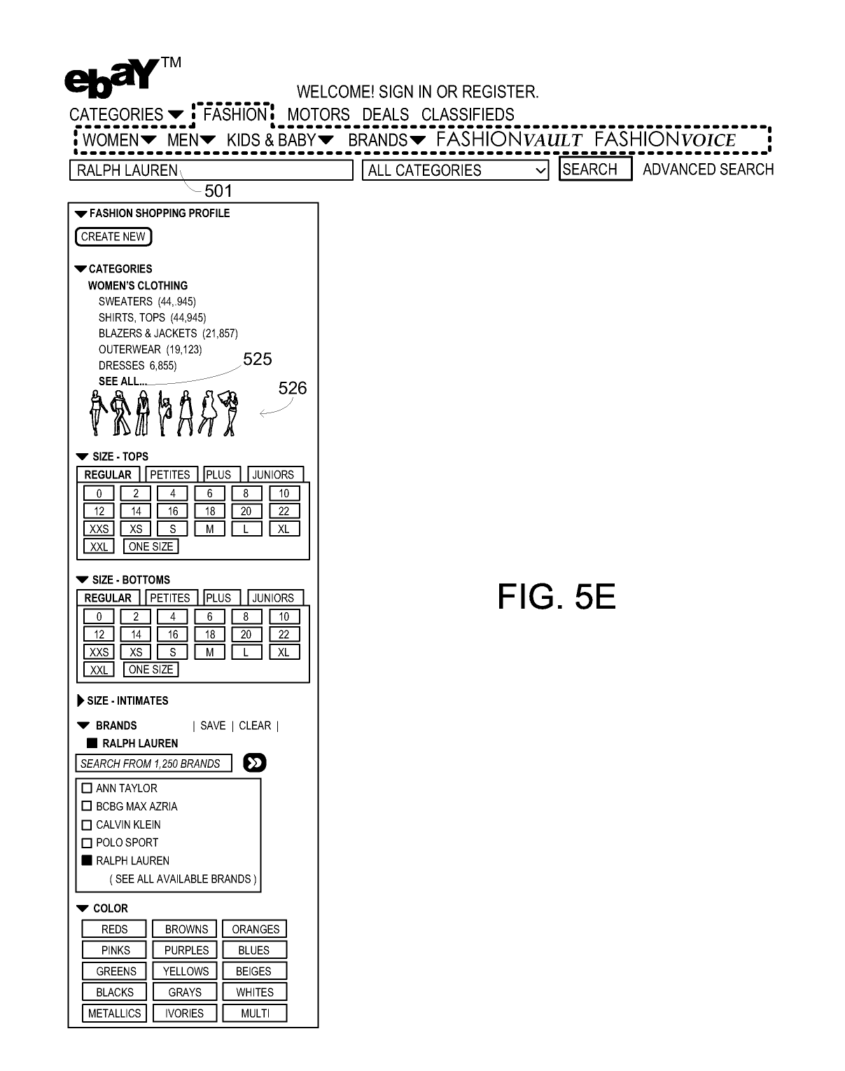

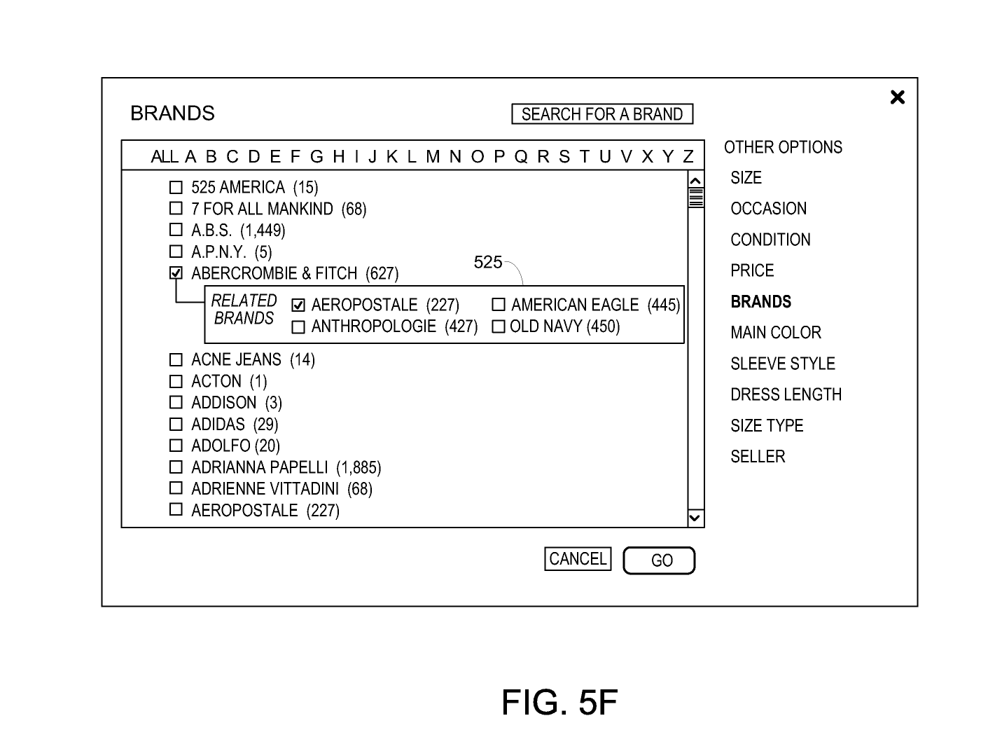

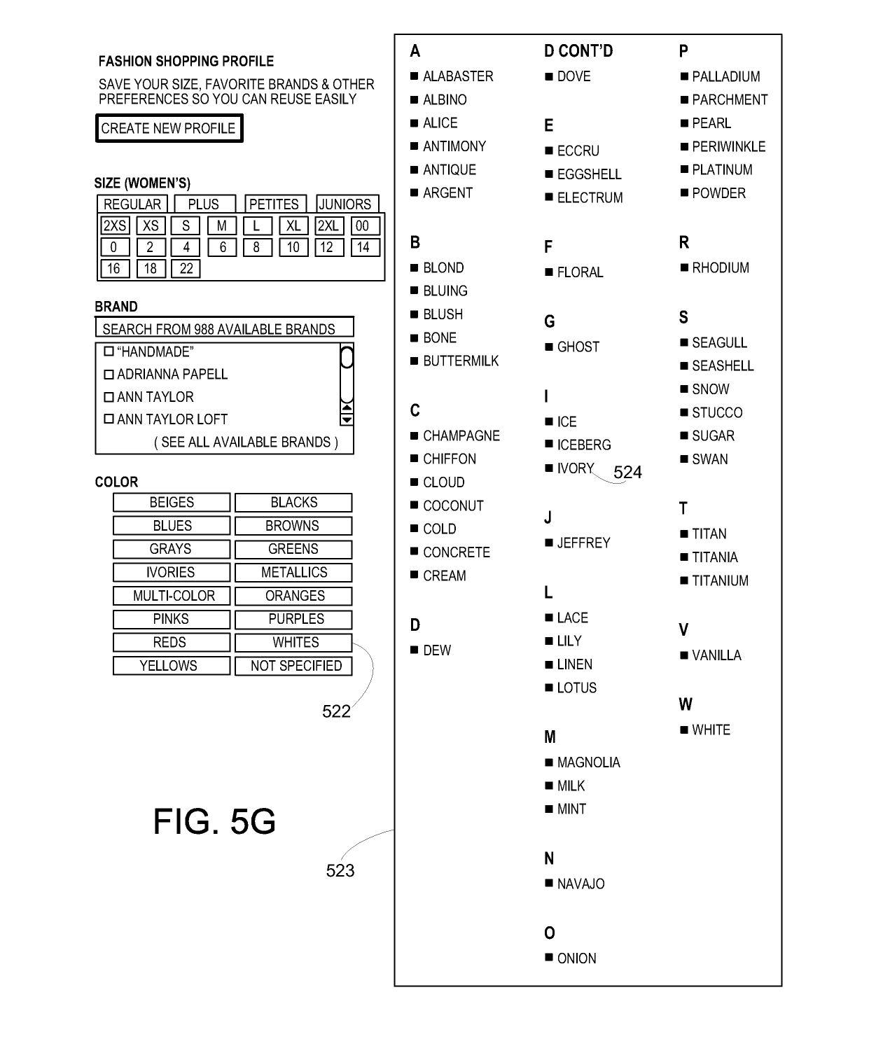

An illustration of this may be seen in FIG. 5A where a shopper has entered a brand “Ralph Lauren” directly into a search box 501 of FIG. 5A, as opposed to entering the product search by using a selectable category button 503 such as under “Fashion” in a classic browser-like search. The search may, of course, be begun by using a browser search such as by selecting a product category under the “Fashion” button. Using the search box 501 and the brand as a keyword gives the shopper an alternate way of getting to a product category, and the combination of being able to enter the search by way of a category button 503 and the search box 501 allows the shopper to get to a product category more quickly with less likelihood of experiencing “shopper fatigue.” The search described below, then, may be undertaken by either course of action.

### Shop by Aspect

As discussed above, a study of shopper's shopping habits has also discovered that shoppers shop by style, brand, material, or other aspects of the product being shopped for. However, ecommerce sites do not provide the shopper with an aspect selection until the shopper has searched down the search tree. For example, a shopper may not see a brand of an item until the shopper is searching at a lower level of the search. An example of the usual ecommerce site landing page that exhibits the foregoing shortcomings may be seen in the above reference U.S. patent application Ser. No. 13/073,926. Yet, as mentioned, shoppers often shop by brand, or size, or color, or material, as examples of aspects. To provide product aspects early in the search enhances the shopping and helps insure that the shopper does not lose interest as she proceeds down the search tree. One example of this may be seen in FIG. 5A. As seen in FIG. 5A, when the shopper enters the search term “Ralph Lauren,” in the search box 501, aspects such as specialty sizes 502, brands 517, color 507, material, 508, and the like, may be presented, for example in a left navigation pane, to the shopper along with choices of product category men's clothing, women's clothing, infant's clothing, and the like, nearly immediately and very early in the search.

To determine what the shopper may be looking for, a question 505 such as “Are you looking for?” may be presented. An answer to this question may be selected by the shopper from a series of silhouettes illustrating item categories for the brand entered, ranging, for example, from Ralph Lauren men's clothing to Ralph Lauren women's shoes, Ralph Lauren women's bags, Ralph Lauren's men's accessories, Ralph Lauren women's accessories, and Ralph Lauren men's accessories as presented in FIG. 5A. If there are more categories than available silhouettes because of search page space limitations, other categories such as Ralph Lauren Home & Garden, Health & Beauty, and the like may be listed in words in section 513 of the interface of FIG. 5A. A selectable “See All Categories” tab 506 causes a pop-up such a layer 515 in FIG. 5B to be displayed. When a category such as Ralph Lauren's women's clothes 510, and sub-category “Dresses” 511 is selected, silhouettes of dresses may be presented for a dress category silhouettes 512 as shown in FIG. 5D with various styles of dresses in silhouette also selectable, such as sleeve style icons 514, dress length icons 516, and the like. Selection of the desired silhouette will search for dresses of the selected type of aspect. If desired, an auto-suggest function, such as described in U.S. patent application Ser. No. 12/916,198, entitled Traffic Driver for Suggesting Stores, filed Oct. 29, 2010, incorporated herein by reference in its entirety, and assigned in common this the application for this patent, may be used to speed up the brand entering process. An alternate embodiment of presenting categories in terms of silhouettes in the left navigation pane may be seen in FIG. 5E. In either embodiment, selecting a particular category such as Women's Clothing, as one example, may allow types of women's clothing to appear in selectable silhouette form in the left navigation pane as shown at 526. Selecting a type of woman's clothing may allow selectable style silhouettes to be exposed as discussed above with respect to FIG. 5D. The style of women's clothing such as sweaters, shirts, and the like, if lack of room prevents additional types of women's clothing to be listed in the navigation pane, may be listed using the See All button 525 which may enable a pop up layer, as explained above with respect to 515 of FIG. 5B.

### Search Available Brands

It has also been learned by studying the habits of shoppers that shoppers sometimes become confused because the brand scroll box 519 of FIG. 5A displays only a limited number of the most popular brands. The shopper may be searching for a brand that is not displayed in the limited number of brands in the scroll box 519. This may be alleviated by providing a selectable “see all available brands” button 521 in FIG. 5A that allows the shopper to search all or most available brands, in addition to searching the scroll of brands 519. Selecting the “see all available brands” button 521 may cause a pop-up layer 523 of FIG. 5C which may be used to search all or most available brands if the shopper so desires. This may be done by selecting a letter in the pop-up layer 523 to enable searching brands beginning with that letter in the pop-up layer 523.

### Related Brands

As discussed above, if a shopper is shopping for a first brand and is then presented with a second, perhaps related, brand, there may be a tendency for the shopper to shop in both the first brand and the second brand. This benefits both the shopper, who may have a better probability of finding what the shopper wants or needs, and the ecommerce site, that may experience higher sales. Therefore it may be helpful to suggest multiple brands to a shopper. One way this may be accomplished is to present the shopper with not only the brand for which the shopper may be searching, but also present the shopper with brands related to that brand.

One way to implement displaying related brands to the shopper may be seen in FIG. 5F. As one example, when a shopper selects the “see all available brands” button 521 in FIG. 5A enabling the pop-up layer 523 of FIG. 5C, and then selects, for example, Abercrombie & Fitch, a Related Brands layer 525 in FIG. 5G may pop up and present the shopper with brands related to the brand being searched. In this case, brands related to Abercrombie and Fitch may be Aeropostale, American Eagle, Anthropologie and Old Navy. In the illustration, the shopper selects to shop in Aeropostale in addition to Abercrombie & Fitch.

### Color Selector

Referring again to FIG. 5A, a color selector table 507, sometimes referred to as a “color picker,” is shown. As mentioned earlier, sellers have voiced concern that a listing process allows only one color, for example, red, to be selected when preparing a listing for a product. Faced with a choice of merely red, sellers may complain that a color of their product may be burgundy or brick red, but their only choice of a color for listing their product is red. Shoppers, likewise, may complain that the item purchased is not as described because it is really burgundy but was listed merely as red. Study of shoppers' and sellers' views about ecommerce sites led to a discovery that if sellers and shoppers understand that products listed as a given color may be within a range of shades within that color, they may be more content with that understanding and the complaints discussed above may be reduced. Upon discovering this problem, it can be alleviated by pluralizing, for example, by adding an “s” to each of the colors in the color picker 507 so that sellers and shoppers, understand that a color means a range of shades within the color. Testing shoppers and sellers determined that by merely adding an “s” at the end of a color in the color picker 507, people now tend to think the pluralized color means a range for reds; from brick red, to burgundy, to an entire range of reds. Sellers select a color from the pluralized group when listing a product and shoppers may search colors in terms of pluralized colors, with both sellers and shoppers understanding that the color selected may be within a range of shades of that color. Consequently, shoppers and sellers feel more comfortable with this visual treatment.

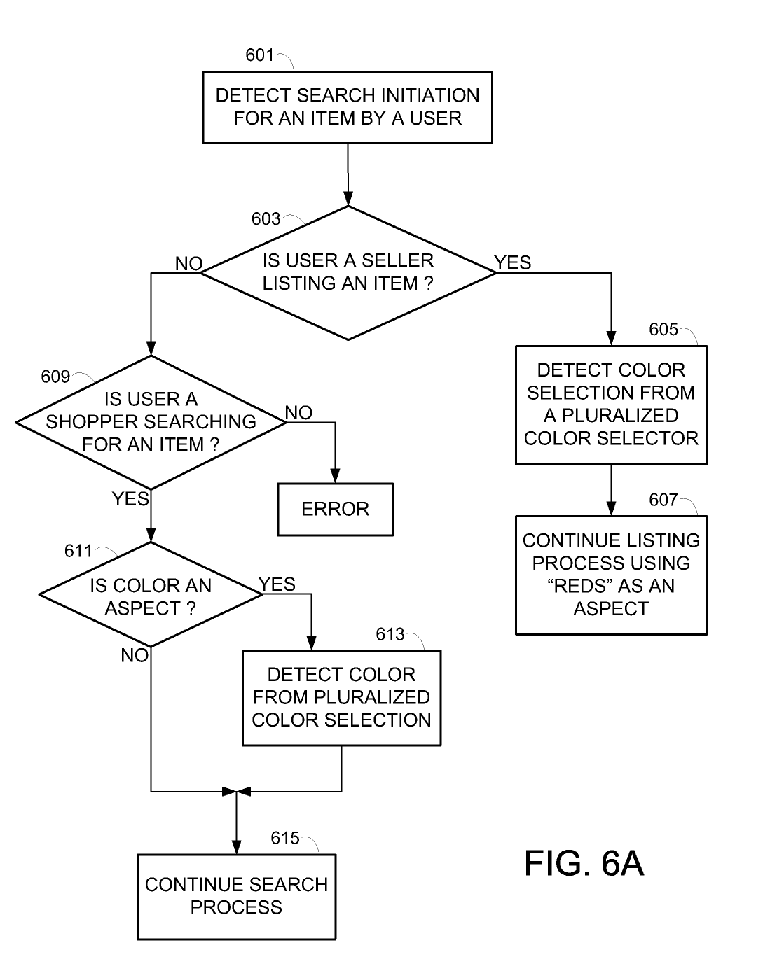

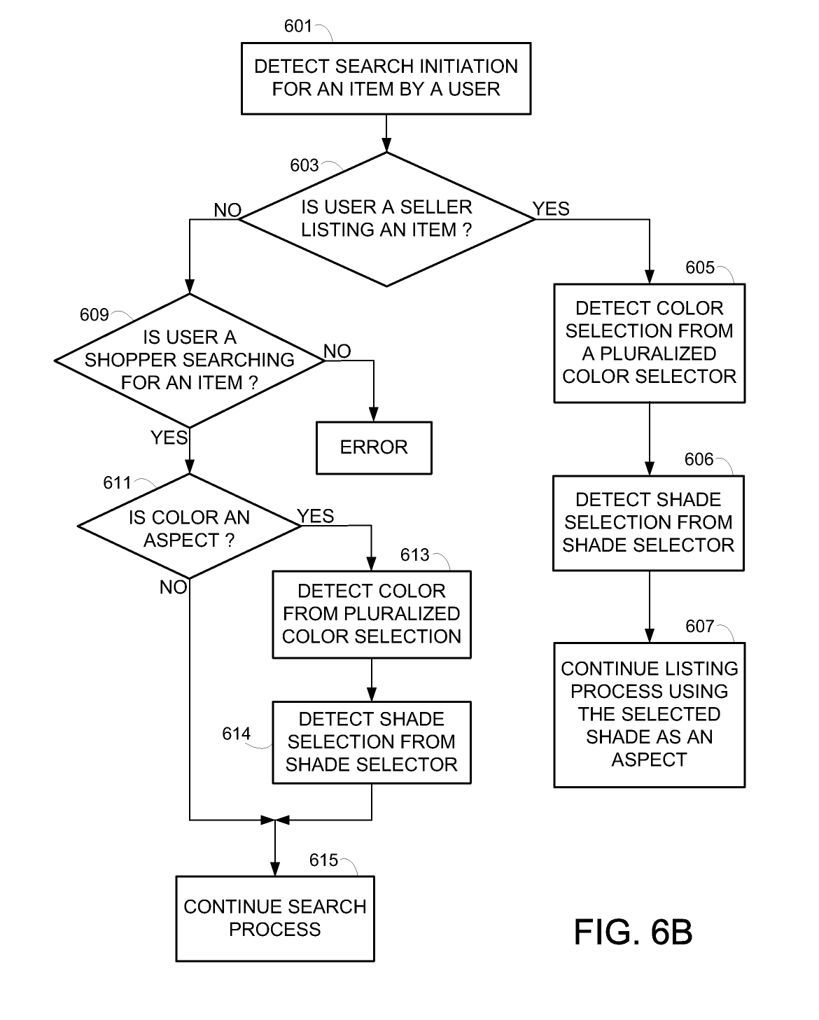

A method of using the color picker 507 of FIG. 5A may be seen in FIG. 6A. Those of ordinary skill in the art will understand that the steps of FIG. 6A may be implemented in an order differing from those discussed here without departing from the embodiment. During a search by a user, the system may detect, at operation 601, an initiation of a search by the user. Decision point 603 determines whether the user may be a seller listing an item or a shopper searching for an item. If the user is a seller, then at operation 605, the system may detect a color selection by the seller from a pluralized color selector such as the color picker 507 of FIG. 5A. The system may then continue with a listing process at operation 607, using the color description “reds” as an aspect of the listing.

Decision 603 may determine that the user is not a seller listing an item and at decision 609 may determine whether the user is a shopper searching for an item. If the user is a shopper, then at decision 611, the system may determine whether color may be an aspect of the item. If color is an aspect, then at operation 613, the system may detect a color (e.g., “reds”) selected by a shopper from a pluralized color selector such as the color picker 507 of FIG. 5A. The system may then continue with the search process as at operation 615 using, for example, “reds” as an aspect. The selection may then result in the listing of items of various shades of red with the aspect expressly stated as “reds” indicating a range of shades of red.

In another embodiment that allows a more precise selection of color, once the seller selects a color, a pop-up window or layer with selectable tabs or buttons for a more nearly precise shade of the color may be presented with additional shades of the color. For example, if a white button 522 in FIG. 5G is selected as the color, a layer 523 with choices including shades of white like ivory, off-white, polar white, pearl, and other shades of white, may be presented. The user (e.g., a seller listing an item for sale or a shopper looking for a particular shade of white) may select the desired shade from the layer 523.

A method of using the color picker 507 of FIG. 5G may be seen in FIG. 6B. Those of ordinary skill in the art will understand that the steps may be implemented in an order differing from those discussed here without departing from the embodiment described in FIG. 6B. FIG. 6B is similar to FIG. 6A with operations 601 and 603 of FIG. 6B being the same as in FIG. 6A. The system may, at FIG. 6B, detect at operation 605 color selection by a seller from a pluralized color selector, such as the color white button 521 of FIG. 5G. The system may then at operation 606 detect a shade selected by the seller from the layer 523 of FIG. 5G. For example, the shade may be an ivory selection 524 as shown in FIG. 5G. The system then continues with the listing process as at operation 607, expressly using the ivory shade of white as an aspect.

Decision 603 of FIG. 6B may determine that the user is not a seller listing an item, and at decision 609 may determine that the user may be a shopper searching for an item. If the user is a shopper, then at decision 611, the system may determine whether color may be an aspect of the item. If color is an aspect, then at operation 613 the system may detect the color selected by a shopper from the color selector 507, such as the whites button 522 of FIG. 5G. The system may then, at operation 614, detect a shade of white, such as the ivory selection 524, selected by a seller from the layer 523 of FIG. 5G. The search then continues with the search process as at operation 615, returning one or more items with color ivory in the search results.

### Modules, Components and Logic

Certain embodiments are described herein as including logic or a number of components, modules, or mechanisms. A component is a tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein.

In various embodiments, a component may be implemented mechanically or electronically. For example, a component may comprise dedicated circuitry or logic that is permanently configured (e.g., as a special-purpose processor) to perform certain operations. A component may also comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software) may be driven by cost and time considerations.

Accordingly, the term “component” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components are temporarily configured (e.g., programmed), each of the components need not be configured or instantiated at any one instance in time. For example, where the components comprise a general-purpose processor configured using software, the general-purpose processor may be configured as respective different components at different times. Software may accordingly configure a processor, for example, to constitute a particular component at one instance of time and to constitute a different component at a different instance of time.

Components can provide information to, and receive information from, other components. Accordingly, the described components may be regarded as being communicatively coupled. Where multiple of such components exist contemporaneously, communications may be achieved through signal transmission (e.g., over appropriate circuits and buses) that connect the components. In embodiments in which multiple components are configured or instantiated at different times, communications between such components may be achieved, for example, through the storage and retrieval of information in memory structures to which the multiple components have access. For example, one component may perform an operation, and store the output of that operation in a memory device to which it is communicatively coupled. A further component may then, at a later time, access the memory device to retrieve and process the stored output. Components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of some of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations thereof. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### EXAMPLE THREE-TIER SOFTWARE ARCHITECTURE

In some embodiments, the described methods may be implemented using one of a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data inputted through the interface level. The logic tier may communicate the results of such processing to the interface tier, and/or to a backend, or storage tier. The processing performed by the logic tier may relate to certain rules, or processes that govern the software as a whole. A third, storage tier, may be a persistent storage medium, or a non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. The three-tier architecture may be implemented using one technology, or, a variety of technologies. The example three-tier architecture, and the technologies through which it is implemented, may be realized on one or more computer systems operating, for example, as a standalone system, or organized in a server-client, peer-to-peer, distributed or some other suitable configuration. Further, these three tiers may be distributed between more than one computer systems as various components.

### Components

Example embodiments may include the above described tiers, and processes or operations about constituting these tiers may be implemented as components. Common to many of these components is the ability to generate, use, and manipulate data. The components, and the functionality associated with each, may form part of standalone, client, server, or peer computer systems. The various components may be implemented by a computer system on an as-needed basis. These components may include software written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique.

Software for these components may further enable communicative coupling to other components (e.g., via various Application Programming interfaces (APIs)), and may be compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above described components across a distributed programming environment as distributed computing components. For example, an interface component (e.g., an interface tier) may form part of a first computer system that is remotely located from a second computer system containing a logic component (e.g., a logic tier). These first and second computer systems may be configured in a standalone, server-client, peer-to-peer, or some other suitable configuration. Software for the components may be written using the above described object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

### A System of Transmission Between a Server and Client

Example embodiments may use the OSI model or TCP/IP protocol stack model for defining the protocols used by a network to transmit data. In applying these models, a system of data transmission between a server and client, or between peer computer systems may for example include five layers comprising: an application layer, a transport layer, a network layer, a data link layer, and a physical layer. In the case of software, for instantiating or configuring components, having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

Although an embodiment has been described with reference to specific example embodiments, it will be evident that various modifications and changes may be made to these embodiments without departing from the broader spirit and scope of the embodiment. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

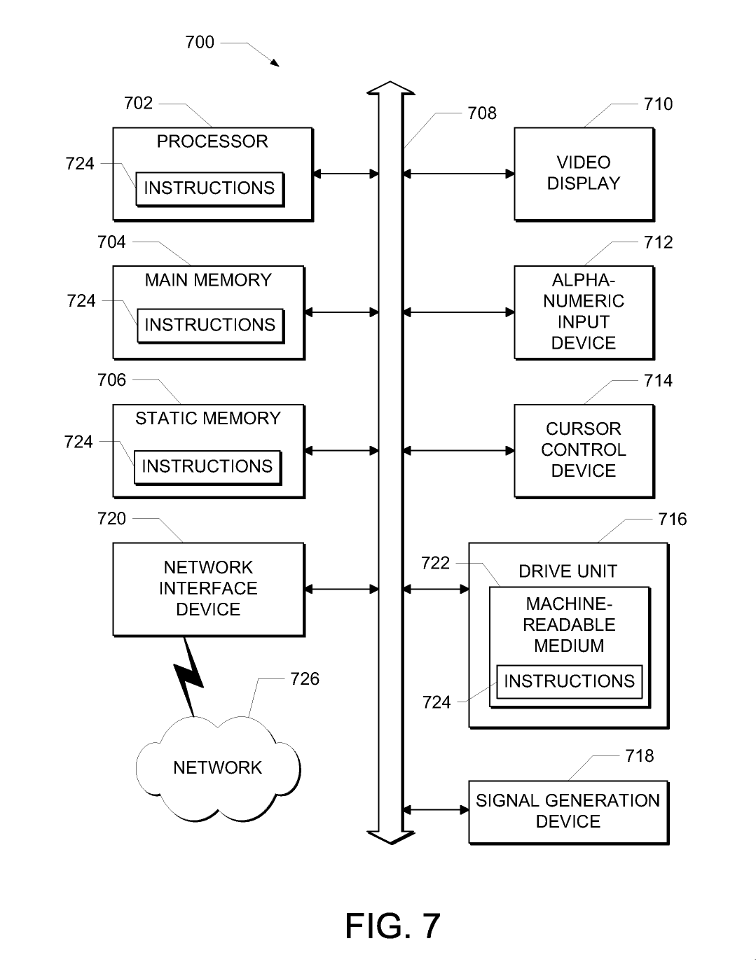

FIG. 7 shows a diagrammatic representation of a machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein. The term “machine-readable medium” shall accordingly be taken to include, but not be limited to, solid-state memories, optical and magnetic media, and carrier wave signals.

### Data Structures

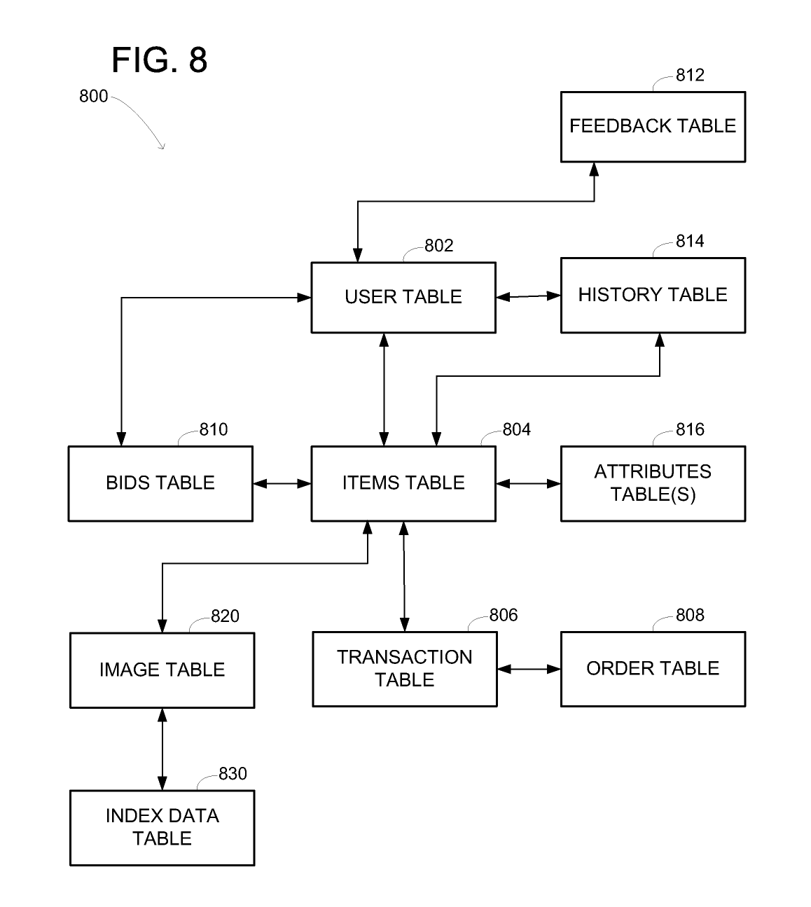

FIG. 8 is a high-level entity-relationship diagram of an example embodiment, illustrating various tables 800 that may be maintained within the databases 35 to 37, and that are utilized by and support the applications 30 and 32. A user table 802 contains a record for each registered user of the networked system 12, and may include identifier, address and financial instrument information pertaining to each such registered user. A user may operate as a seller, a buyer, or both, within the networked system 12. In one example embodiment, a buyer may be a user that has accumulated value (e.g., commercial or proprietary currency), and is accordingly able to exchange the accumulated value for items that are offered for sale by the networked system 12.

The tables 800 also include an items table 804 in which are maintained item records for goods and services that are available to be, or have been, transacted via the networked system 12. Each item record within the items table 804 may furthermore be linked to one or more user records within the user table 802, so as to associate a seller and one or more actual or potential buyers with each item record.

The items table 804 may be connected to an image table which contains images associated with the respective items or item listings in the items table 804. The image table 820 is in turn connected to an index data table 830 which contains index data as described in detail above.

A transaction table 806 contains a record for each transaction (e.g., a purchase or sale transaction) pertaining to items for which records exist within the items table 804.

An order table 808 is populated with order records, each order record being associated with an order. Each order, in turn, may be with respect to one or more transactions for which records exist within the transaction table 806.

Bid records within a bids table 810 each relate to a bid received at the networked system 12 in connection with an auction-format listing supported by an auction application 32. A feedback table 812 is utilized by one or more reputation applications 50, in one example embodiment, to construct and maintain reputation information concerning users. A history table 814 maintains a history of transactions to which a user has been a party. One or more attributes tables 816 record attribute information pertaining to items for which records exist within the items table 804. Considering only a single example of such an attribute, the attributes tables 816 may indicate a currency attribute associated with a particular item, the currency attribute identifying the currency of a price for the relevant item as specified in by a seller.

Thus, a method and system to index images and to perform an image-based search in a network-based marketplace have been described. Although the present method and system have been described with reference to specific example embodiments, it will be evident that various modifications and changes may be made to these embodiments without departing from the broader spirit and scope of the application. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method of searching comprising:
receiving an indication of an entry of a brand name from a client machine;
responsive to receiving an indication of the entry of the brand name, providing selectable images of product categories of the brand and selectable images of product aspects for rendering at a client machine;
receiving an indication of a selection of a product category and of a product aspect from the client machine;
responsive to receiving of the indication of the selection of the product category and of the product aspect, providing selectable images of styles of products of the selected product category for rendering at the client machine, and
responsive to receiving of a selection of an image of a style of a product, providing a number of selectable images of at least one product of the selected product category of the brand, the at least one product being of the selected style of the product and the selected product aspect, for rendering at the client machine.

2. The method of claim 1, the product aspects including a color of the product, the color identified by a word indicating the color.

3. The method of claim 2, the word indicating the color being pluralized to indicate a range of shades of the color.

4. The method of claim 2, the product aspects including a color of the product expressed in a shade of the color.

5. The method of claim 2, further including receiving an indication of selection of the word indicating the color; and responsive to the receiving the indication of the word indicating the color, providing selectable images comprising a plurality of shades of the color.

6. The method of claim 5, further including receiving an indication of the selection of an image of one of the plurality of shades of the color, and responsive to receiving of an indication of the selection of the image, using the selected shade of the color as a product aspect.

7. A non-transitory computer-readable storage medium having embedded therein a set of instructions which, when executed by one or more processors of a computer, causes the computer to execute the following operations:
receiving an indication of entering a brand name from a client machine;
responsive to detecting the indication of the entering of the brand name, providing selectable images of product categories of the brand and selectable images of product aspects, for rendering at a client machine;
receiving an indication of selection of an image of a product category and the selection of an image of a product aspect from the client machine;
responsive to receiving an indication of the selection of an image of the product category and the selection of an image of the product aspect, providing selectable images of styles of products of the selected product category for rendering at the client machine; and
responsive to detecting selection of the image of the product style, presenting a number of selectable images of at least one product of the selected product category of the brand, the at least one product being of the selected style and the selected product aspect, for rendering at the client machine.

8. The computer-readable storage medium of claim 7, the product aspects including a color of a product, the color identified by a word indicating the color.

9. The computer-readable storage medium of claim 8, the word indicating the color being pluralized to indicate a range of shades of the color.

10. The computer-readable storage medium of claim 7, the product aspects including a color of the product expressed by a shade of the color.

11. The computer-readable storage medium of claim 10, the operations further including receiving an indication of the selection of the color and, responsive to the receiving the indication of the selection of the color, providing a plurality of selectable images comprising shades of the selected color.

12. The computer-readable storage medium of claim 11, the operations further including receiving an indication of the selection of one of the plurality of selectable images comprising shades of the color, and using the selected shade of the color of the selected image as the product aspect.

13. A system for searching comprising:
a computer processor and computer storage configured to
detect an indication of the entering of a brand name from a client machine;
responsive to detecting the indication of the entering of the brand name, provide selectable images of product categories of the brand and selectable images of product aspects, for rendering at a client machine;
detect an indication of the selection of an image of a product category and an image of a product aspect from the client machine;
responsive to detecting an indication of the selection of the image of the product category and of the image of a product aspect, provide selectable images of styles of products of the selected product category, for rendering at the client machine, and
responsive to detecting an indication of the selection of an image of a product style, provide selectable images of at least one product of the selected product category of the brand, the at least one product being of the selected style and aspect, for rendering at the client machine.

14. The system of claim 13, the computer processor and computer storage wherein the product aspects include color of a product, the color identified by a word indicating the color.

15. The system of claim 14, the word indicating the color being pluralized to indicate a range of shades of the color.

16. The system of claim 13, wherein the product aspects include the color of a product expressed in a shade of the color.

17. The system of claim 16, the computer processor and computer storage further configured to receive selection of the color; and responsive to received selection of the color, provide a plurality of selectable images comprising shades of the color.

18. The system of claim 17, the computer processor and computer storage further configured to receive selection of one of the plurality of images of a shade of the color and, responsive to receiving the selection of the image of the shade of the color, use the shade of the color as f the product aspect.

19. A method in a networked publication system, the method comprising:
providing a selectable plurality of words representing colors, the plurality of words being pluralized;
receiving an indication of the selection of one of the plurality of words; and
using the color indicated by the selected one of the plurality of words, indicating colors as an aspect of a product in a product search.

20. The method of claim 19, further including, responsive to the receiving an indication of the selection of one of the plurality of words indicating colors, providing a plurality of selectable images representing shades of the selected color.

21. The method of claim 20, further including responsive to receiving an indication of the selection of one of the plurality of selectable images representing shades of the color, using the shade of the color of the selected image as an aspect of the product in the product search.

22. A non-transitory computer-readable storage medium having embedded therein a set of instructions which, when executed by one or more processors of a computer, causes the computer to execute the following operations:
providing a selectable plurality of words representing colors, the plurality of words being pluralized;
detecting an indication of the selection of one of the plurality of words; and
using the color indicated by the selected one of the plurality of words, indicating colors as an aspect of a product in a product search.

23. The non-transitory computer-readable storage medium of claim 22, the operations further including, responsive to detecting the indication of the selection of one of the plurality of words indicating colors, providing a plurality of selectable images representing shades of the indicated color.

24. The non-transitory computer-readable storage medium of claim 23, the operations further including, responsive to detecting an indication of the selection of one of the plurality of selectable images representing shades of the color, using the shade of the color of the selected image as an aspect of the product in the product search.

25. The non-transitory computer readable storage medium of claim 24, the operations further including detecting an indication of the selection of one of the plurality of images representing shades of the color and, responsive to detecting indication of the selection of the image using the shade of the color represented by the selected image as an aspect of the product in the product search.
